SEQUENCE LISTING (35 sequences)

SEQ ID NO: 1 - DNA, 22 bp, Artificial Sequence
  Sequencing short read
taaaataattgtccgtcaactt

SEQ ID NO: 2 - DNA, 22 bp, Artificial Sequence
  Sequencing short read
ttcgacgtcaaccccagttccg

SEQ ID NO: 3 - DNA, 22 bp, Artificial Sequence
  Sequencing short read
ttctcatgtttattaaaataat

SEQ ID NO: 4 - DNA, 22 bp, Artificial Sequence
  Sequencing short read
cgaccatttctgaatattaaaa

SEQ ID NO: 5 - DNA, 22 bp, Artificial Sequence
  Sequencing short read
ggcgaccatttaggaatattaa

SEQ ID NO: 6 - DNA, 22 bp, Artificial Sequence
  Sequencing short read
cgggcgaccatattaaaataat

SEQ ID NO: 7 - DNA, 22 bp, Artificial Sequence
  Sequencing short read
ggcgggcgacccaaggaatatt

SEQ ID NO: 8 - DNA, 22 bp, Artificial Sequence
  Sequencing short read
cggcgggcgacaatattaaaat

SEQ ID NO: 9 - DNA, 22 bp, Artificial Sequence
  Sequencing short read
acaacggcgggaaggaatatta

SEQ ID NO: 10 - DNA, 21 bp, Artificial Sequence
  Sequencing short read
agacaacggcgtcaaggaata

SEQ ID NO: 11 - DNA, 86 bp, Lupinus angustifolius
agacaacggcgggcggccatttctcatgtttcgacgtcaaggaattttaaaataattgtctcgttccccagttccgtcaacttaca

SEQ ID NO: 12 - DNA, 31 bp, Artificial Sequence
  Adapter
ctcaggcatcactcgattcctccgagaacaa

SEQ ID NO: 13 - DNA, 46 bp, Artificial Sequence
  adapter
tgagtccgtagtgagctaaggaggcagcatacggcagaagacgaac

SEQ ID NO: 14 - DNA, 30 bp, Artificial Sequence
  Sequencing short read
aattcattttattaacagagcaaggggtca

SEQ ID NO: 15 - DNA, 87 bp, Lupinus angustifolius
ctctgttattaagcgccggtaaagagtacaaagctgcagttcgaattcattttattaacagagcaaggggtcaaggcagttgaatgt

SEQ ID NO: 16 - DNA, 30 bp, Artificial Sequence
  Sequencing short read
aattcgaactgcagctttgtactctttagg

SEQ ID NO: 17 - DNA, 50 bp, Artificial Sequence
  Sequencing short read
aattcatgcaaatgcccccatcgctatccccaatgaaatccccgatctcg

SEQ ID NO: 18 - DNA, 43 bp, Artificial Sequence
  Sequencing short read
aattctttttaatgctatcatcagcggtctttagcatcccata

SEQ ID NO: 19 - DNA, 43 bp, Artificial Sequence
  Sequencing short read
aattctttttaatgctcttctcagtagtctttagcatctcatg

SEQ ID NO: 20 - DNA, 43 bp, Artificial Sequence
  Sequencing short read
aattctttttagatagtggaaatggtttacacccctagagttc

SEQ ID NO: 21 - DNA, 43 bp, Artificial Sequence
  Sequencing short read
aattctttttcctttttatgttggattgattttgtttttcgtg

SEQ ID NO: 22 - DNA, 43 bp, Artificial Sequence
  Sequencing short read
aattctttttgcatgacacattgcgagagcacgcgtctgcgca

SEQ ID NO: 23 - DNA, 43 bp, Artificial Sequence
  Sequencing short read
aattcaaaaactctctgtttgacaacttttacagtgaccaggg

SEQ ID NO: 24 - DNA, 43 bp, Artificial Sequence
  Sequencing short read
aattcaaaaatttctttagtgcggtaaatgcctcatcgacttt

SEQ ID NO: 25 - DNA, 43 bp, Artificial Sequence
  Sequencing short read
aattcaaaaccgttttcctctaaacataaagaagagataatgt

SEQ ID NO: 26 - DNA, 43 bp, Artificial Sequence
  Sequencing short read
aattcaaaacctttgagcacaagaggtgaggaagttaccaaaa

SEQ ID NO: 27 - DNA, 43 bp, Artificial Sequence
  Sequencing short read
aattcaaaactacttttaaaacctatcatggacacttccaatt

SEQ ID NO: 28 - DNA, 43 bp, Artificial Sequence
  Sequencing short read
aattcaaaaggacaaagcaaaggttgaacaaataaaatcagca

SEQ ID NO: 29 - DNA, 92 bp, Artificial Sequence
  Sequencing short read
aattcactttcaattgaatttcgcttcaacattctttcgattgactttcaatcagtttaacgattaaactttgaaagcgataaatttccaaa

SEQ ID NO: 30 - DNA, 92 bp, Artificial Sequence
  Sequencing short read
aattcactttcaattgaatttcgcttcaacattctttcgattgactggcaatcagtggcccgattaaactttgaaagttttaaatttccaaa

SEQ ID NO: 31 - DNA, 92 bp, Artificial Sequence
  Sequencing short read
aattcactttcaattgaatttcgcttcaacattctttcgattgactttcaatcatacgcctgattaaactaactaagcgataaatttcgttt

SEQ ID NO: 32 - DNA, 92 bp, Artificial Sequence
  Sequencing short read
aattcactttcaattgaatttcgcttcaacattctttcgattgactactttccagtttaacgattaaactttggggatcctaaatttccaaa

SEQ ID NO: 33 - DNA, 92 bp, Artificial Sequence
  Sequencing short read
aattcactttcaattgaatttctcttcaacattctttcgattgactttcaatcagtttaacgattaaactttgaaagcgataaatttccaaa

SEQ ID NO: 34 - DNA, 92 bp, Artificial Sequence
  Sequencing short read
ctaagtgcccattttgaatttcgcttcaacaacgggatccacctggttcaatcagtttaacgattaaactttgaaagcgataaatttccaaa

SEQ ID NO: 35 - DNA, 92 bp, Artificial Sequence
  Sequencing short read
ttaatcgggacaattgaaccctcacgagggattctccgataactgcttcaatcactttaacgattaaactttgaaagcgataaatttccaaa

(19) United States
(12) Patent Application Publication
(10) Pub. No.: US 2015/0120210 A1
(43) Pub. Date: Apr. 30, 2015

(54) METHOD AND DEVICE FOR LABELLING SINGLE NUCLEOTIDE POLYMORPHISM SITES IN GENOME

(71) Applicants: Ye Tao, Shenzhen (CN); Zequn Zheng, Shenzhen (CN); Zihao Feng, Shenzhen (CN); Yingrui Li, Shenzhen (CN); Huanming Yang, Shenzhen (CN); Jun Wang, Shenzhen (CN); Jian Wang, Shenzhen (CN)

(72) Inventors: Ye Tao, Shenzhen (CN); Zequn Zheng, Shenzhen (CN); Zihao Feng, Shenzhen (CN); Yingrui Li, Shenzhen (CN); Huanming Yang, Shenzhen (CN); Jun Wang, Shenzhen (CN); Jian Wang, Shenzhen (CN)

(73) Assignee: BGI TECH SOLUTIONS CO., LTD., Shenzhen (CN)

(21) Appl. No.: 14/369,318

(22) PCT Filed: Dec. 29, 2011
(86) PCT No.: PCT/CN2011/002207

§ 371 Date: Jun. 27, 2014

(51) Int. Cl. G06F 19/22

(52) U.S. Cl. CPC G06F 19/22
USPC 702/20

(57) ABSTRACT

Disclosed are a method and a device for labelling single nucleotide polymorphism site in a genome. The above-mentioned method comprises: the single-end RAD sequences from the genomes of two individuals are obtained; the single-end RAD sequences are filtered to remove unqualified sequences; the sequencing depth of the sequences from the genomes of two individuals is aligned in pairs and without gaps to determine the SNP sites.

### TECHNICAL FIELD

Embodiments of the present disclosure generally relate to a field of bioinformatics, more particularly, to a method of determining a single nucleotide polymorphism marker in a genome and a device thereof.

### BACKGROUND

Single nucleotide polymorphism (SNP) mainly refers to DNA polymorphism resulted from a single nucleotide variation in a genome level. SNP is one of the most common heritable variations, occupying more than 90% of all known polymorphisms. SNP extensively exists in human genome, with one SNP site averagely in every 500 to 1000 base pairs, of which the total number may reach to 3 million or more. The obtained SNP information may have many important applications, such as genetic map construction, genotype, molecular marker-assistant breeding, disease detection, and etc.

Nowadays, Next-Generation DNA sequencing technology is a high-throughput sequencing technology with low cost, of which the fundamental is sequencing by synthesis. For example, Solexa sequencing method randomly fragments DNA strands using a physical method firstly, then a specific adaptor is ligated to the obtained fragments at both ends, in which the specific adaptor has an amplification primer sequence. During sequencing, DNA polymerase is used to synthesize a complementary strand to the fragment to be analyzed; then the base sequence is obtained by detecting a fluorescence signal carried by the newly-synthesized base, so as to obtain a sequence of the fragment to be analyzed (http://www.illumina.com).

The Next-Generation sequencing technology has been extensively applied in many fields of bioscience, particular in study on polymorphisms among different individuals of one species, more particularly in polymorphism of SNP site. A traditional method of obtaining SNP is aligning reads obtained by sequencing an individual to a reference sequence using software, to obtain information of SNP site of the individual. Available procedures comprise: aligning reads to a reference sequence using SOAP software, finding an SNP site using SOAP SNP software^{1,2}. A general procedure is shown as FIG. 1.

Currently, a species having a reference sequence may be subjected to SNP marker development conveniently; however, non-model organisms basically have no reference sequence. In the case without reference sequence, technical bottlenecks exist in the traditional method of obtaining SNP.

### REFERENCE

1. Li, R. et al. SNP detection for massively parallel whole-genome resequencing. Genome Research 19, 1124 (2009).
2. Li, R. et al. SOAP2: an improved ultrafast tool for short read alignment. Bioinformatics 25, 1966-7 (2009).

### SUMMARY

The present disclosure is provided in view of the above problems.

One purpose of the present disclosure is to provide a technical solution for determining a single nucleotide polymorphism marker in a genome.

According to one aspect of the present disclosure, there is provided a method of determining a single nucleotide polymorphism marker in a genome, which comprises following steps:

obtaining RAD single-end reads from two genomes of individuals respectively;

subjecting the RAD single-end reads to a first filtration, to remove unqualified reads and respectively obtain first filtered reads from the two genomes of individuals;

calculating sequencing depths of the first filtered reads from the two genomes of individuals respectively;

subjecting the first filtered reads to a second filtration, to remove reads having sequencing depth of 1 and respectively obtain second filtered reads from the two genomes of individuals;

subjecting the second filtered reads from the two genomes of individuals to a pairwise alignment without gap allowance, to determine the SNP marker in the genome.

Preferably, allowed mismatches in the pairwise alignment without gap allowance are determined based on a length of the second filtered reads.

Preferably, the step of subjecting the second filtered reads from the two genomes of individuals to a pairwise alignment without gap allowance comprises:

partitioning each of the second filtered reads from one of the two genomes of individuals into m+1 of first substrings, wherein m represents allowed mismatches;

building a hash table by means of taking the first substrings partitioned from one of the two genomes of individuals as a key of the hash table, and taking reads containing the first substrings as a value of the hash table;

partitioning each of the second filtered reads from the other one of the two genomes of individuals into m+1 of second substrings;

retrieving the hash table indexed by the second substrings, to obtain seed reads from the one of the two genomes of individuals;

subjecting the second filtered reads from the other one of the two genomes of individuals and the seed reads from the one of the two genomes of individuals to the pairwise alignment without gap allowance, to determine the SNP marker in the genome.

Preferably, the method of determining a single nucleotide polymorphism marker in a genome further comprises: removing an SNP site located at a repetitive region of DNA sequence.

Preferably, the SNP site located at the repetitive region of DNA sequence meets following criteria, wherein:

two or more copies of a read present in one of the two genomes of individuals, wherein the two or more copies containing the SNP site locate at a different region in the other one of the two genomes of individuals;

and/or

a plurality of copies of a read present in one of the two genomes of individuals, of which has a high sequencing depth; one of the plurality of copies containing the SNP site presents in the other one of the two genomes of individuals, a plurality of the same copies of the read present in the other one of the two genomes.

Preferably, the unqualified reads meet at least one of the following criteria:

containing more than 50% bases having a sequencing quality lower than a preset low-quality threshold;

and/or

containing more than 10% undetermined bases;

and/or

containing an exogenous sequence;

and/or

containing a plurality of initial bases of which are not from an enzyme-digested end sequence.

According to another aspect of the present disclosure, there is provided a device for determining a single nucleotide polymorphism marker in a genome, which comprises:

a reads obtaining apparatus, configured to obtain RAD single-end reads from two genomes of individuals respectively;

a first reads filtering apparatus, configured to subject the RAD single-end reads to a first filtration, to remove unqualified reads and respectively obtain first filtered reads from the two genomes of individuals;

a sequencing depth determining apparatus, configured to calculate sequencing depths of the first filtered reads from the two genomes of individuals respectively;

a second reads filtering apparatus, configured to subject the first filtered reads to a second filtration, to remove reads having sequencing depth of 1 and respectively obtain second filtered reads from the two genomes of individuals;

an SNP site determining apparatus, configured to subject the second filtered reads from the two genomes of individuals to a pairwise alignment without gap allowance, to determine the SNP marker in the genome.

Preferably, allowed mismatches in the pairwise alignment without gap allowance are determined based on a length of the second filtered reads.

Preferably, the site determining apparatus comprises:

a hash table building unit, configured to partition each of the second filtered reads from one of the two genomes of individuals into m+1 of first substrings, and build a hash table by means of taking the first substrings partitioned from one of the two genomes of individuals as a key of the hash table, and taking reads containing the first substrings as a value of the hash table, wherein m represents allowed mismatches;

a seed read determining unit, configured to partition each of the second filtered reads from the other one of the two genomes of individuals into m+1 of second substrings, and retrieve the hash table indexed by the second substrings, to obtain seed reads from the one of the two genomes of individual;

an SNP site determining unit, configured to subject the second filtered reads from the other one of the two genomes of individuals and the seed reads from the one of the two genomes of individuals to the pairwise alignment without gap allowance, to determine the SNP marker in the genome.

Preferably, the device for determining a single nucleotide polymorphism marker in a genome further comprises: an SNP site filtering apparatus, configured to remove an SNP site located at the repetitive region of DNA sequence.

Preferably, the SNP site located at the repetitive region of DNA sequence meets at least one of following criteria, wherein

two or more copies of a read present in one of the two genomes of individuals, wherein the two or more copies containing the SNP site locate at a different region in the other one of the two genomes of individuals;

and/or

a plurality of copies of a read present in one of the two genomes of individuals, of which has a high sequencing depth; one of the plurality of copies containing the SNP site presents in the other one of the two genomes of individuals, a plurality of the same copies of the read present in the other one of the two genomes.

Preferably, the unqualified reads meet the following criteria:

containing more than 50% bases have a sequencing quality lower than a preset low-quality threshold;

and/or

containing more than 10% undetermined bases;

and/or

containing an exogenous sequence;

and/or

containing a plurality of initial bases of which are not from an enzyme-digested end sequence.

One advantage of the present disclosure lies in that: RAD sequencing data of two individuals are directly subjected to alignment, to determine information of an SNP site in RAD segment, which simplified complexity of genome analysis and reduce sequencing cost.

These and other features and advantages of embodiments of the present disclosure will become apparent more readily appreciated from the following detailed descriptions made with reference the accompanying figures.

### BRIEF DESCRIPTION OF THE DRAWINGS

FIG. 1 is a schematic diagram showing a method of determining an SNP marker in prior art;

FIG. 2 is a schematic diagram showing every step of RAD sequencing technology;

FIG. 3 is a flow chart showing a method of determining a single nucleotide polymorphism marker in a genome according an embodiment of the present disclosure;

FIG. 4 is a schematic diagram showing an example of RAD single-end sequencing of a genome;

FIG. 5 is a schematic diagram showing statistics of sequencing depth information of read;

FIG. 6 is a schematic diagram showing storage of sequencing depth information of read;

FIG. 7 is a flow chart showing reads alignment of two genomes of individuals according to an embodiment of the present disclosure;

FIG. 8 is a schematic diagram showing an example of FIG. 7;

FIG. 9 is a schematic diagram showing an example of SNP site in repetitive region.

FIG. 10 is a schematic diagram showing an application according to the method of determining a single nucleotide polymorphism marker in a genome of the present disclosure;

FIG. 11 is a distribution diagram showing RAD-tag sequencing depth;

FIG. 12 is a structural chart showing a device for determining a single nucleotide polymorphism marker in a genome according to an embodiment of the present disclosure;

FIG. 13 is a structural chart showing a device for determining a single nucleotide polymorphism marker in a genome according to another embodiment of the present disclosure.

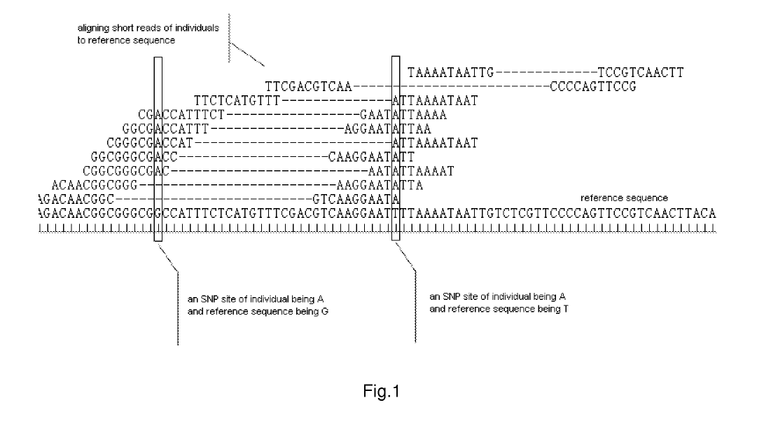

### DETAILED DESCRIPTION

Reference will be made in detail to embodiments of the present disclosure. It should note that: unless specific statement, otherwise relative arrangements, numeric expressions and values of components and steps expounded in these embodiments are not constructed to limit the scope of the present disclosure.

Meanwhile, it would be appreciated that, to facilitate description, a size of each part shown in the figures is not plotted in accordance with an actual scaling relationship.

Following descriptions to at least one explanatory embodiment are actually just illustrative, never as any restrictions to the present disclosure, and application or usage thereof.

It may not specifically discuss technology, method and device known to those ordinary skilled in the relative art, but in an appropriate case, technology, method and device should be regarded as one part of the granted specification.

In all embodiments shown and discussed herein, any specific value should be explained as exemplary, not being constructed to a restriction. Therefore, other examples of the exemplary embodiments may have different value.

It should be noted that similar labels and alphabets represent similar items in the following figures, thus, once a certain item is defined in a figure, then further discussions are not required in subsequent figures.

Directing to the problems in the prior art, the present disclosure provides a new bioinformatics analysis solution, to process RAD (Restriction-site Association DNA) data and find SNP site information in RAD fragment, which may break through bottlenecks presenting in the non-model organisms lack reference sequence, and simplify genome complexity, as well as reduce sequencing cost.

Some concepts regarding the technical solution of the present disclosure are introduced below.

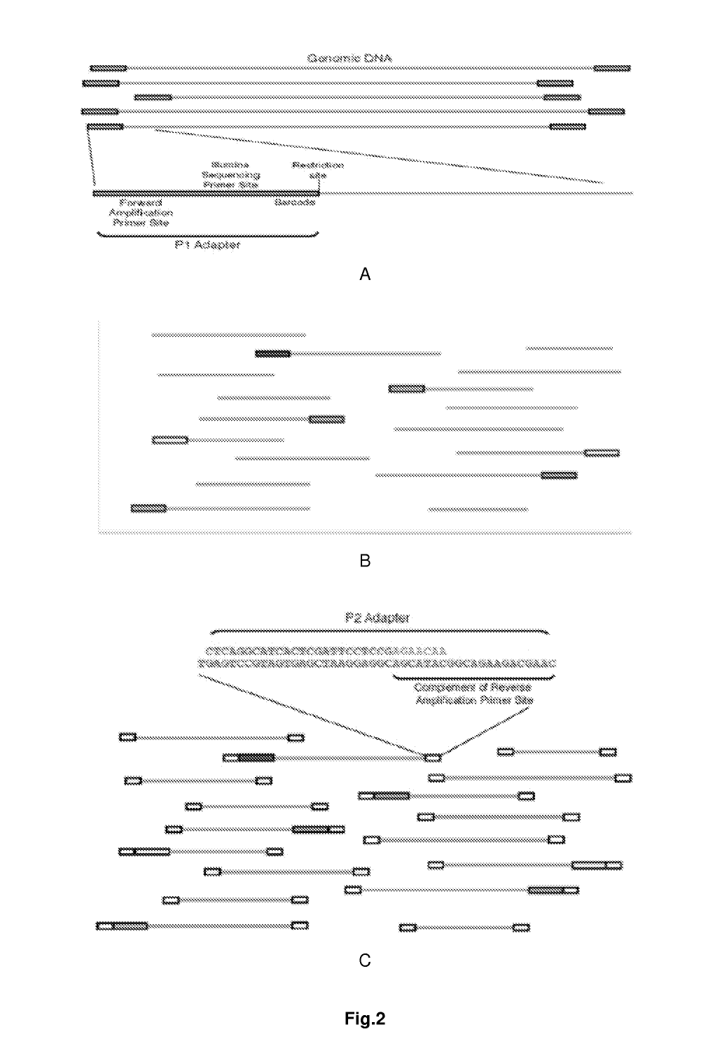

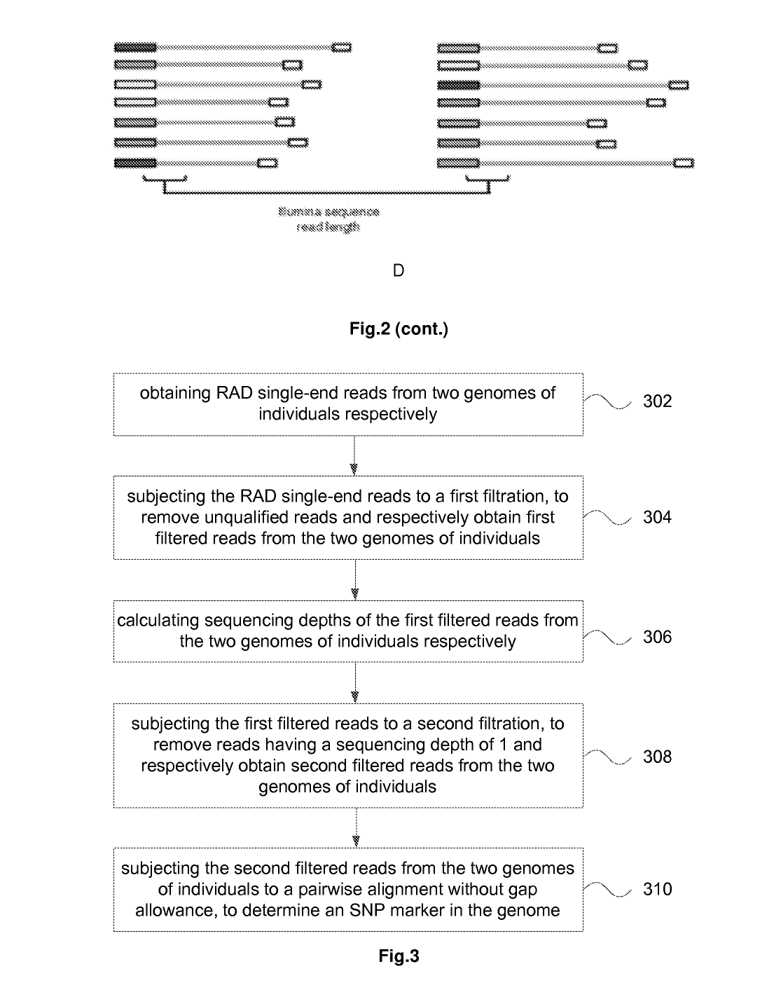

The RAD sequencing technology uses a new way of library construction, of which a specific procedure is shown as FIG. 2: digesting a specific site of DNA using a restriction enzyme firstly; randomly fragmenting the digested DNA using a physical method, selecting DNA having a specific length by agarose gel DNA separation technology secondly; then ligating a specific amplification adaptor and sequencing adaptor to the selected DNA at ends, to construct a library for high throughput sequencing on computer.

Hash table is a data structure directly accessed based on key value. In another word, hash table accesses a record by mapping the key value into a position of the hash table, so as to accelerate a searching speed. Such mapping function is known as a hash function, arrays for holing the records are known as the hash table. Indexing data using the hash table basically increases as a rising data volume linearly, and a character string constituted with “ATCGN” makes a very low possibility of a key value conflict. Then, there is an excellent property during processing massive sequencing data.

First pigeonhole principle, if more than n objects are put into n drawers, then at least one drawer contains 2 or more objects. Based on this principle, it can be deduced that if n−1 objects are put into n drawers, then at least one drawer contains none of the objects.

FIG. 3 is a flow chart showing a method of determining a single nucleotide polymorphism marker in a genome according to an embodiment of the present disclosure.

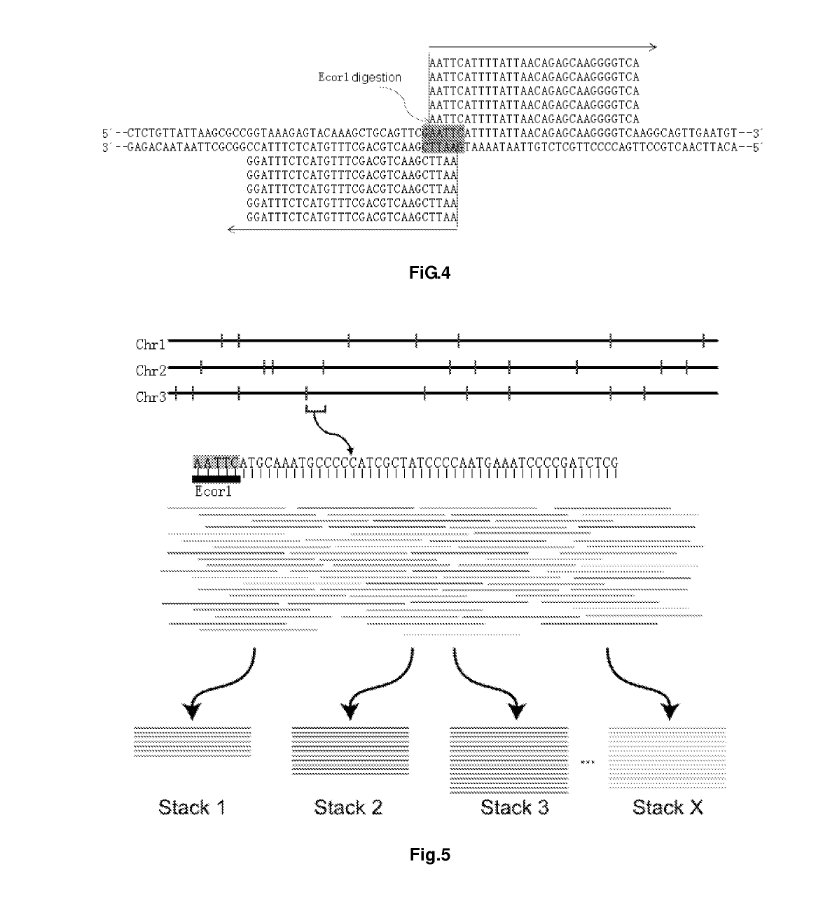

As shown in FIG. 3, in step 302, RAD single-end reads from two genomes of individuals are obtained respectively. FIG. 4 is a schematic diagram showing an example of RAD single-end sequencing of a genome. It can be seen from FIG. 4 that restriction enzyme Ecor1 is used to identify a palindrome of “GAAATTC” in DNA molecule and digest the DNA molecule between base G and base A; the digested DNA molecule is fragmented into a short sequence fragment using a physical method; the short sequence fragment is ligated to an adaptor at one digested end for single-end sequencing, in which a sequencing read length is generally 50 nt, or maybe 100 nt.

In step 304, the RAD single-end reads are subjected to a first filtration, to remove unqualified reads and respectively obtain first filtered reads from the two genomes of individuals. For example, after being received, the high-throughput RAD single-end reads are subjected to a first filtration, to remove unqualified reads and respectively obtain first filtered reads form the two genomes of individuals, in which the high-throughput sequencing technology may be Illumina GA sequencing technology, or may be other high-throughput sequencing technologies in prior art. The unqualified reads, for example, meet at least one of the following criteria: 1) containing more than 50% bases having a sequencing quality lower than a preset low-quality threshold. The low-quality threshold depends on specific sequencing technology and sequencing environment, for example, the low-quality threshold is set as the single base sequencing quality being lower than 20; 2) containing more than 10% undetermined bases (such as N in Illumina GA sequencing result); containing an exogenous sequence introduced from other experiments except sample adaptor sequence, such as various adaptor sequences. If a sequence containing the exogenous sequence, such sequence is regarded as an unqualified read; if a sequence does not contain a plurality of initial bases which belong to a sequence having an enzyme-digested end, then such sequence are removed (for example, if a read does not contain initial bases of “AATTC” obtained using restriction enzyme Ecor1, then such read is removed).

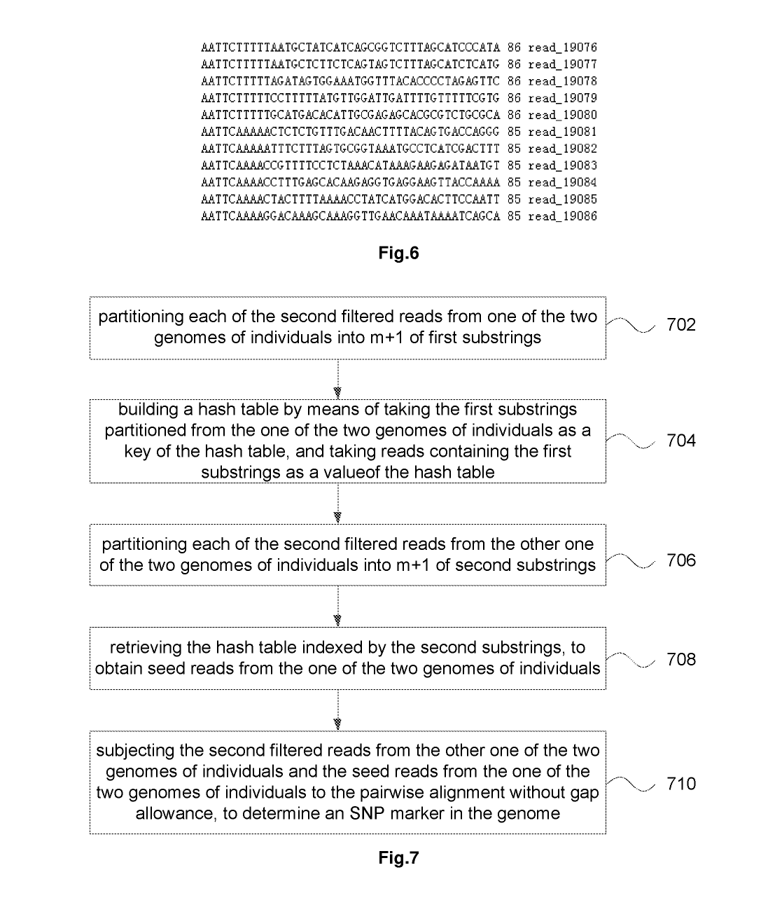

In step 306, sequencing depths of the first filtered reads from the two genomes of individuals are respectively calculated. For example, taking reads information of the first filtered reads of every individual as a key of hash table, a value of hash table is used for counting reads. By such, sequencing depth information of every read in one individual may be obtained. A specific procedure is shown in FIG. 5. Stack information may be saved in a way shown in FIG. 6, in FIG. 6, the first column represents RAD sequence information; the second column represents frequencies of the RAD sequence being sequenced, i.e., sequencing depth information; the third column represents ID information of the RAD sequence.

In step 308, the first filtered reads are subjected to a second filtration, to remove reads having sequencing depth of 1 and respectively obtain second filtered reads from the two genomes of individuals. Those reads having sequencing depth of 1 normally results from an incorrect sequencing. Removing information of reads having the sequencing depth of 1, decreases the number of an incorrect SNP site resulted from the incorrect sequencing.

In step 310, the second filtered reads from the two genomes of individuals are subjected to a pairwise alignment without gap allowance, to determine an SNP marker in the genome. The counted data of the second filtered reads from the two genomes of individuals are subjected to the pairwise alignment without gap allowance. During alignment, the allowed mismatches depends on the sequencing length, for example, in the case of the sequencing length being shorter than 50 nt, the allowed mismatches is 1; in the case of the sequencing length being shorter than 100 nt, the allowed mismatches is 2. For example, the allowed mismatch is 1, i.e., one SNP marker is maximum allowed within one RAD-tag (Restriction-site Associated DNA tag).

In the above embodiments, the method of determining SNP site information in RAD fragments between two individuals by directly handling RAD sequencing data, does not depend on a reference sequence, which enlarges the application scope of SNP marker and overcomes some technical bottlenecks of traditional methods of obtaining SNP marker. The specific region of genome is enriched and sequenced by RAD sequencing approach, which reduces genome complexity and sequencing cost.

If compared using traditional character strings, an aligning relationship between the obtained reads from individual A and the obtained reads from individual B needs a length of n*m for comparing character strings having the number of 50 to 100 characters. Since n and m obtained from the sequencing data are usually in a million magnitudes, assuming that a computer may process an alignment of character strings 100,000 times per second, then a period of 10 days is still required for running all of the alignment.

Directing to problems that the traditional alignment approach has a large amount of calculation, a slow calculation speed and a low efficiency, an embodiment of the present disclosure provides a new alignment method, of which the basic idea is that: partitioning read from one of the two individuals, building a hash table indexed by the partitioned substrings. If one mismatch is allowed, then read of the one individual is cut into two substrings averagely, by such if a certain read of the other one individual contains one mismatch which can be aligned to the mismatch in the reads of the one individual, according to pigeonhole principle, the mismatch may either contained in the left side or in the right side, then there must be one side containing none of the mismatch. In another word, if m mismatches are allowed, then read is partitioned into m+1 substrings, and at least one substring does not contain the mismatch which can be completely aligned. In this case, the partitioned substrings may be used as a seed for building a hash table. For example, if one mismatch is allowed, then the averagely-partitioned substring is taken as a key and the entire read is taken as a value for building a hash table, which realizes indexing the reads. It may rapidly find most reads similar with a read from one individual by the hash table when handling the alignment to a read from the other one individual, which aligns one by one after diminishing scope to find an SNP marker between two individuals.

A specific procedure is shown as FIG. 7:

In step 702, each second filtered read from one of the two individuals (such as individual A) is partitioned into m+1 of first substrings; in which m represents allowed mismatches. For example, if one mismatch is allowed, then read from one of the two individuals is cut into two substrings averagely.

In step 704, the first substrings partitioned from one of the two genomes of individuals are taken as a key of the hash table, for building a hash table, a value in the table corresponding to the key is the reads containing the first substrings in the one of the two individuals. Each of the second filtered reads from the other one of the two genomes of individuals (such as individual B) is subjected to:

step 706, the each of the second filtered reads from the other one of the two genomes of individuals (such as individual B) is partitioned into m+1 of second substrings. Then each one in the m+1 of the second substrings is subjected to:

step 708, the second substrings are taken as an index to search the hash table, to obtain a value in the table corresponding to such substring, so as to obtain all seed reads from one of the two individuals.

step 710, the second filtered reads from the other one of the two genomes of individuals and the seed reads from the one of the two individuals are subjected to the pairwise alignment without gap allowance, to determine an SNP marker in the genome.

By using the alignment method according to the above embodiments, the amount of calculation is obviously reduced with a high speed and a high efficiency, which overcomes timing bottlenecks of traditional methods.

In an embodiment of the present disclosure, after determining the SNP marker by aligning reads from two individuals, an SNP site in a repetitive region needs to be removed. FIG. 9 shows two cases of the SNP site located in the repetitive region:

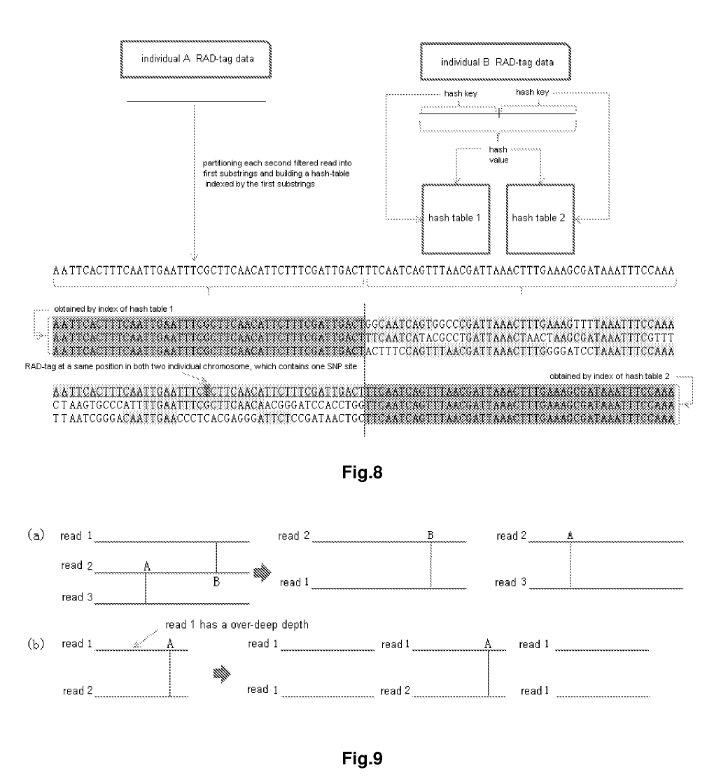

Case 1: Sequence 2 of one individual (such as individual A) contains two or more copies in genome, while these two or more copies containing the SNP site located at a different region in the other individual (such as individual B), of which an aligned result is shown in FIG. 8 (a).

Case 2: Sequence 1 of one individual (such as individual A) contains a plurality of copies of a read presenting in one of the two genomes of individuals, of which has a high sequencing depth; one of the plurality of copies containing the SNP site presents in the other one of the two genomes of individuals, a plurality of the same copies of the read present in the other one individual (such as individual B), of which an aligned result is shown in FIG. 8 (b).

Other repetitive sequence leads to more complex cases, which are all on the basis of these two cases, to remove an SNP result in the repetitive region during the process of handling data.

By filtering, aligning RAD-tag data from two individuals, filtering the repetitive region, a set of RAD-tag SNP marker supported by sufficient depth information between two individuals is finally obtained.

It can be seen from the above embodiments that, the technical solution of the present disclosure may handle RAD sequencing data to find SNP markers in a certain specie population without a reference sequence.

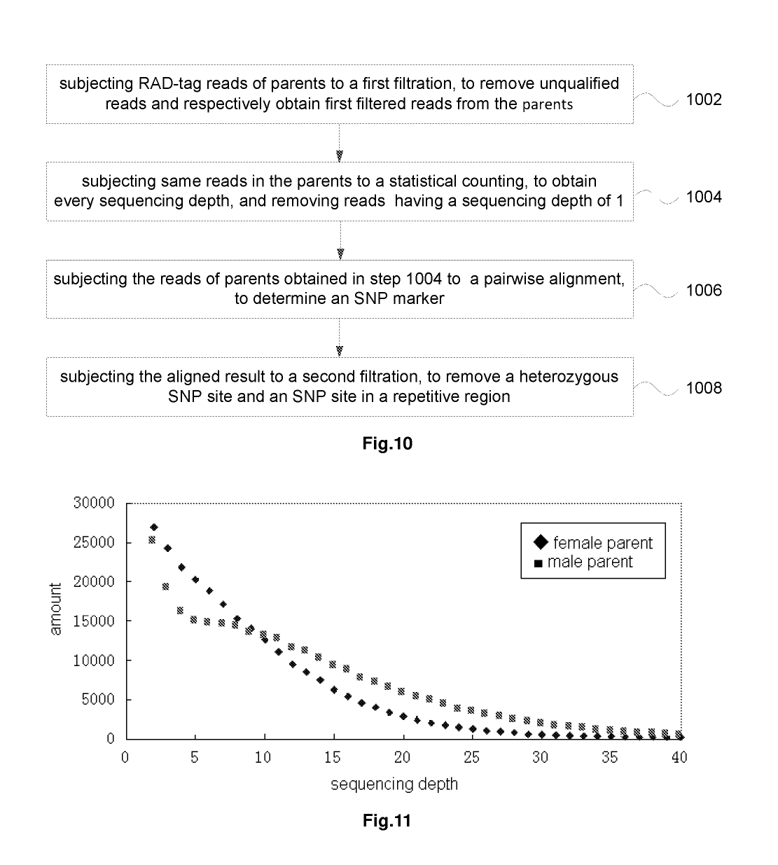

FIG. 10 is a schematic diagram showing an application according to the method of determining a single nucleotide polymorphism marker in a genome of the present disclosure. Date in the embodiment are RAD-tag sequencing data of parents of Lupinus angustifolius L. inbred population.

A specific operation procedure is shown as FIG. 10, in step 1002, RAD-tag sequencing data of parents are subjected to a first filtration to remove unqualified reads and obtain a statistics of effective RAD sequencing data shown in Table 1, in accordance with sequencing quality value, N content and whether or not containing enzyme digested end sequence.

TABLE 1
The statistics of effective RAD sequencing data of Lupinus angustifolius L.

| sample of | | |
|---|---|---|
| Lupinus angustifolius L. | read length (bp) | data volume (bp) |
| male parent | 92 | 3,346,853,648 |
| female parent | 92 | 2,476,540,272 |

In step 1004, same reads in the two individuals are subjected to a statistical counting, to obtain a depth of every read, and reads having sequencing depth of 1 are removed. FIG. 11 is a distribution diagram showing RAD-tag sequencing depth, of which a statistical result is shown in Table 2.

TABLE 2
The RAD-tag statistics of Lupinus angustifolius L.

| sample of | number of | RAD-tag average |
|---|---|---|
| Lupinus angustifolius L. | RAD-tag | sequencing depth |
| male parent | 372,549 | 23 |
| female parent | 321,728 | 19 |

In step 1006, the counted data of the reads from two individuals are subjected to the pairwise alignment to determine the SNP marker, for example the allowed mismatches for alignment is 2, i.e., two SNP markers are maximum allowed within one RAD-tag.

In step 1008, a heterozygous SNP site and an SNP site in a repetitive are removed from the aligned result.

In summary, through the above steps, totally 17,902 of homozygous SNP markers are found in two individuals of male parent and female parent of Lupinus angustifolius L.

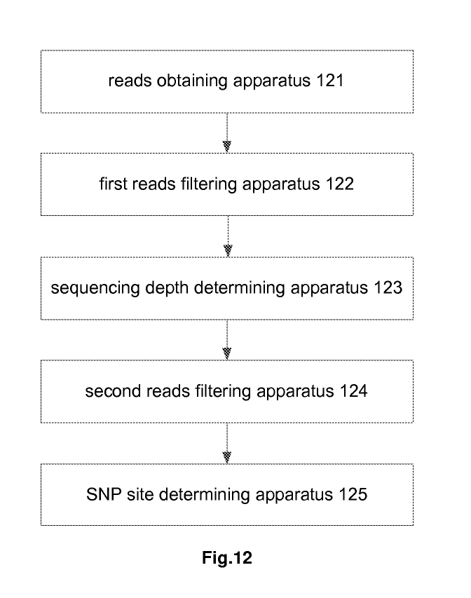

FIG. 12 is a structural chart showing a device for determining a single nucleotide polymorphism marker in a genome according to an embodiment of the present disclosure.

As shown in FIG. 12, the device comprises:

a reads obtaining apparatus 121, configured to obtain RAD single-end reads from two genomes of individuals respectively.

a first reads filtering apparatus 122, configured to subject the RAD single-end reads to a first filtration, to remove unqualified reads and respectively obtain first filtered reads from the two genomes of individuals; in which the unqualified reads meet at least one of the following criteria:

containing more than 50% bases having a sequencing quality lower than a preset low-quality threshold;

and/or

containing more than 10% undetermined bases;

and/or

containing an exogenous sequence;

and/or

containing a plurality of initial bases of which are not from an enzyme-digested end sequence,

a sequencing depth determining apparatus 123, configured to calculate sequencing depths of the first filtered reads from the two genomes of individuals respectively.

a second reads filtering apparatus 124, configured to subject the first filtered reads to a second filtration, to remove reads having a sequencing depth of 1 and respectively obtain second filtered reads from the two genomes of individuals;

an SNP site determining apparatus 125, configured to subject the second filtered reads from the two genomes of individuals to a pairwise alignment without gap allowance, to determine the SNP marker in the genome, in which the pairwise alignment without gap allowance may be set with allowed mismatches, and the allowed mismatches may be determined based on a length of the second filtered reads.

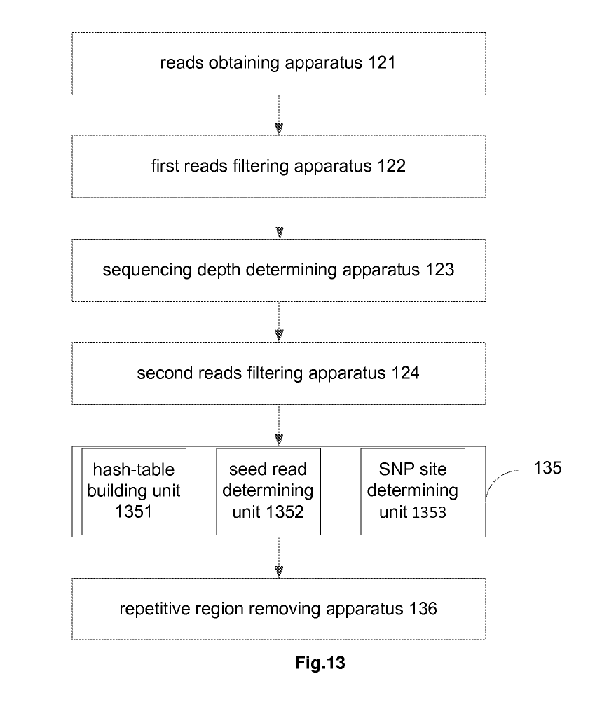

FIG. 13 is a structural chart showing a device for determining a single nucleotide polymorphism marker in a genome according to another embodiment of the present disclosure. Comparing with FIG. 12, this embodiment further comprises a repetitive region removing apparatus 136. The repetitive region removing apparatus 136 is configured to remove an SNP site located at a repetitive region of DNA sequence. For example, the SNP site located at the repetitive region of DNA sequence meets at least one of following criteria, wherein

two or more copies of a read present in one of the two genomes of individuals, wherein the two or more copies containing the SNP site locate at a different region in the other one of the two genomes of individuals;

a plurality of copies of a read present in one of the two genomes of individuals, of which has a high sequencing depth; one of the plurality of copies containing the SNP site presents in the other one of the two genomes of individuals, a plurality of the same copies of the read present in the other one of the two genomes. According to an embodiment of the present disclosure, the site determining apparatus 135 comprises:

a hash table building unit 1351, configured to partition each of the second filtered reads from one of the two genomes of individuals into m+1 of first substrings, and build a hash table by means of taking the first substrings partitioned from one of the two genomes of individuals as a key of the hash table, and taking reads containing the first substrings as a value of the hash table, wherein m represents allowed mismatches;

a seed read determining unit 1352, configured to partition each of the second filtered reads from the other one of the two genomes of individuals into m+1 of second substrings, and retrieve the hash table indexed by the second substrings, to obtain seed reads from one of the two individuals;

a site determining unit 1353, configured to subject the second filtered reads from the other one of the two genomes of individuals and the seed reads from the one of the two genomes of individuals to the pairwise alignment without gap allowance, to determine the SNP marker in the genome.

The function of every apparatus or unit in FIG. 12 or 13, may refer to the corresponding descriptions in above embodiments regarding the method of the present disclosure, for a consideration of brevity, detailed descriptions will be omitted herein.

It would be appreciated by those skilled in the art that, every apparatus in FIG. 12 and FIG. 13 may be realized by a separated computer processing device, or by integrating an independent device. Functions thereof are illustrated using frames in FIG. 12 and FIG. 13. These function blocks may be realized by hardware, software, firmware, middleware, microcode, hardware description voice or any combinations thereof. For example, one or two function blocks may be realized by means of a code running in microprocessor, digital signal processor (DSP) or any other suitable computer device. The code may represent a process, a function, a subprogram, a program, a routine, a subroutine, a module or any combinations of a command, a data structure or a program statement. The code may locate in a computer readable medium. The computer readable medium may comprise one or more memory devices; for example, the computer readable medium comprises a RAM memorizer, a flash memorizer, a ROM memorizer, an EPROM memorizer, an EEPROM memorizer, a register, a hard disk, a mobile hard disk, a CD-ROM, or any other forms of memory medium well-known in the art. The computer readable medium may further comprise a carrier coding data signal.

The method of determining a single nucleotide polymorphism marker in a genome and the device thereof provided in the present disclosure, directly map RAD sequencing data from two individuals to determine SNP site information in RAD fragments, which breaks through the bottleneck of the non-model organism lacking a reference sequence, thereby simplifies the complexity of genome analysis and reduces sequencing cost.

Here, it has already described the method of determining a single nucleotide polymorphism marker in a genome and the device thereof in details. To avoid shielding the concept of the present disclosure, some details well-known in the art are not descripted. Those skilled in the art may fully understand how to implement the technical solution disclosed herein based on the above description.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure. The scope of the present disclosure is defined by the claims below.

What is claimed is:

1. A method of determining a single nucleotide polymorphism marker in a genome, comprising following steps:
obtaining RAD single-end reads from two genomes of individuals respectively;
subjecting the RAD single-end reads to a first filtration, to remove unqualified reads and respectively obtain first filtered reads from the two genomes of individuals;
calculating sequencing depths of the first filtered reads from the two genomes of individuals respectively;
subjecting the first filtered reads to a second filtration, to remove reads having a sequencing depth of 1 and respectively obtain second filtered reads from the two genomes of individuals;
subjecting the second filtered reads from the two genomes of individuals to a pairwise alignment without gap allowance, to determine the SNP marker in the genome.

2. The method of claim 1, wherein allowed mismatches in the pairwise alignment without gap allowance are determined based on a length of the second filtered reads.

3. The method of claim 1, wherein the step of subjecting the second filtered reads from the two genomes of individuals to a pairwise alignment without gap allowance comprises:
partitioning each of the second filtered reads from one of the two genomes of individuals into m+1 of first substrings, wherein m represents allowed mismatches;
building a hash table by means of taking the first substrings partitioned from one of the two genomes of individuals as a key of the hash table, and taking reads containing the first substrings as a value of the hash table;
partitioning each of the second filtered reads from the other one of the two genomes of individuals into m+1 of second substrings;
retrieving the hash table indexed by the second substrings, to obtain seed reads from the one of the two genomes of individuals; and
subjecting the second filtered reads from the other one of the two genomes of individuals and the seed reads from the one of the two genomes of individuals to the pairwise alignment without gap allowance, to determine the SNP marker in the genome.

4. The method of claim 1, further comprising:
removing an SNP site located at a repetitive region of DNA sequence.

5. The method of claim 4, wherein the SNP site located at the repetitive region of DNA sequence meets at least one of following criteria, wherein
two or more copies of a read present in one of the two genomes of individuals, wherein the two or more copies containing the SNP site locate at a different region in the other one of the two genomes of individuals;
a plurality of copies of a read present in one of the two genomes of individuals, of which has a high sequencing depth; one of the plurality of copies containing the SNP site presents in the other one of the two genomes of individuals, a plurality of the same copies of the read present in the other one of the two genomes.

6. The method of claim 1, wherein the unqualified reads meet at least one of the following criteria:
containing more than 50% bases having a sequencing quality lower than a preset low-quality threshold;
containing more than 10% undetermined bases;
containing an exogenous sequence; and
containing a plurality of initial bases of which are not from an enzyme-digested end sequence.

7. A device for determining a single nucleotide polymorphism marker in a genome, comprising:
a reads obtaining apparatus, configured to obtain RAD single-end reads from two genomes of individuals respectively;
a first reads filtering apparatus, configured to subject the RAD single-end reads to a first filtration, to remove unqualified reads and respectively obtain first filtered reads from the two genomes of individuals;
a sequencing depth determining apparatus, configured to calculate sequencing depths of the first filtered reads from the two genomes of individuals respectively;
a second reads filtering apparatus, configured to subject the first filtered reads to a second filtration, to remove reads having a sequencing depth of 1 and respectively obtain second filtered reads from the two genomes of individuals;
an SNP site determining apparatus, configured to subject the second filtered reads from the two genomes of individuals to a pairwise alignment without gap allowance, to determine the SNP marker in the genome.

8. The device of claim 7, wherein allowed mismatches in the pairwise alignment without gap allowance are determined based on a length of the second filtered reads.

9. The device of claim 7, wherein the site determining apparatus comprises:
a hash table building unit, configured to partition each of the second filtered reads from one of the two genomes of individuals into m+1 of first substrings, and build a hash table by means of taking the first substrings partitioned from one of the two genomes of individuals as a key of the hash table, and taking reads containing the first substrings as a value of the hash table, wherein m represents allowed mismatches;
a seed read determining unit, configured to partition each of the second filtered reads from the other one of the two genomes of individuals into m+1 of second substrings, and retrieve the hash table indexed by the second substrings, to obtain seed reads from the one of the two genomes of individuals;
an SNP site determining unit, configured to subject the second filtered reads from the other one of the two genomes of individuals and the seed reads from the one of the two genomes of individuals to the pairwise alignment without gap allowance, to determine the SNP marker in the genome.

10. The device of claim 7, further comprising:
an SNP site filtering apparatus, configured to remove an SNP site located at the repetitive region of DNA sequence.

11. The device of claim 10, wherein the SNP site located at the repetitive region of DNA sequence meets at least one of following criteria, wherein
two or more copies of a read present in one of the two genomes of individuals, wherein the two or more copies containing the SNP site locate at a different region in the other one of the two genomes of individuals;
a plurality of copies of a read present in one of the two genomes of individuals, of which has a high sequencing depth; one of the plurality of copies containing the SNP site presents in the other one of the two genomes of individuals, a plurality of the same copies of the read present in the other one of the two genomes.

12. The device of claim 7, wherein the unqualified reads meet at least one of the following criteria:
containing more than 50% bases having a sequencing quality lower than a preset low-quality threshold;
containing more than 10% undetermined bases;
containing an exogenous sequence; and
containing a plurality of initial bases of which are not from an enzyme-digested end sequence.
